(19) United States
(12) Patent Application Publication
(10) Pub. No.: US 2006/0009175 A1
(43) Pub. Date: Jan. 12, 2006

(54) Remote controller and ornamental device arrangement

(76) Inventor: Hua Wen Hsu, Taipei (TW)

Correspondence Address: Keith Kline;PRO-TECHTOR INTERNATIONAL SERVICES, 20775 Norada Court, Saratoga, CA, 95070-3018, US

(21) Appl. No.: 10/887,501

(22) Filed: Jul. 7, 2004

(51) Int. Cl. H04B 1/00

(52) U.S. Cl. 455/128

(57) ABSTRACT

A remote controller and ornamental device arrangement is constructed to include a remote controller, which has a casing holding a circuit board and a keypad, and an ornamental device, which has a transparent watertight shell mounted in the remote controller and partially extended out of the top cover shell of the casing for decoration and a floating ornament floating on a liquid inside the transparent watertight shell.

### BACKGROUND OF THE INVENTION

1. Field of the Invention

The present invention relates generally to a remote controller and more particularly, to a remote controller and ornamental device arrangement, which has the remote controller decorated with a floating ornament.

2. Description of the Related Art

Conventionally, when using an electric/electronic home appliance (TV, Stereo system, or the like), the user must approach to the electric/electronic home appliance and then operate the buttons at the control panel of the electric/electronic home appliance. This operation mode is inconvenient to a person who is difficult to walk. In order to eliminate this problem, remote-control design electric/electronic home appliances are developed. By means of a remote controller, the user can control the operation of the controlled electric/electronic home appliance at a distance. A remote controller has operation keys or buttons on the top side for operation by the user. The monotonous outer appearance designs of conventional remote controllers do not attract consumer's eyes.

### SUMMARY OF THE INVENTION

The present invention has been accomplished under the circumstances in view. It is therefore the main object of the present invention to provide a remote controller and ornamental device arrangement, which has the remote controller decorated with a floating ornament so that the remote controller can be used as a display toy when not in operation. To achieve this and other objects of the present invention, the remote controller and ornamental device arrangement comprises a casing, the casing comprising a bottom cover shell, a top cover shell covering the bottom cover shell, and a window in one of the bottom cover shell and the top cover shell at a front side thereof, the bottom cover shell and the top cover shell defining an ornamental device receptacle means; an ornamental device mounted in the ornamental device receptacle means and partially exposed to the outside of the casing; a circuit board mounted inside the casing between the bottom cover shell and the top cover shell; and a keypad mounted within the top cover shell and supported on the circuit board for operation by the user to drive the circuit board to output a wireless control signal through the window to control the operation of an external electronic apparatus.

### BRIEF DESCRIPTION OF THE DRAWINGS

FIG. 1 is an exploded view of a remote controller according to the present invention.

FIG. 2 is an elevational assembly view of the remote controller according to the present invention.

FIG. 3 is another exploded view of the remote controller according to the present invention.

FIG. 4 is a side view in section of the remote controller according to the present invention.

### DETAILED DESCRIPTION OF THE INVENTION

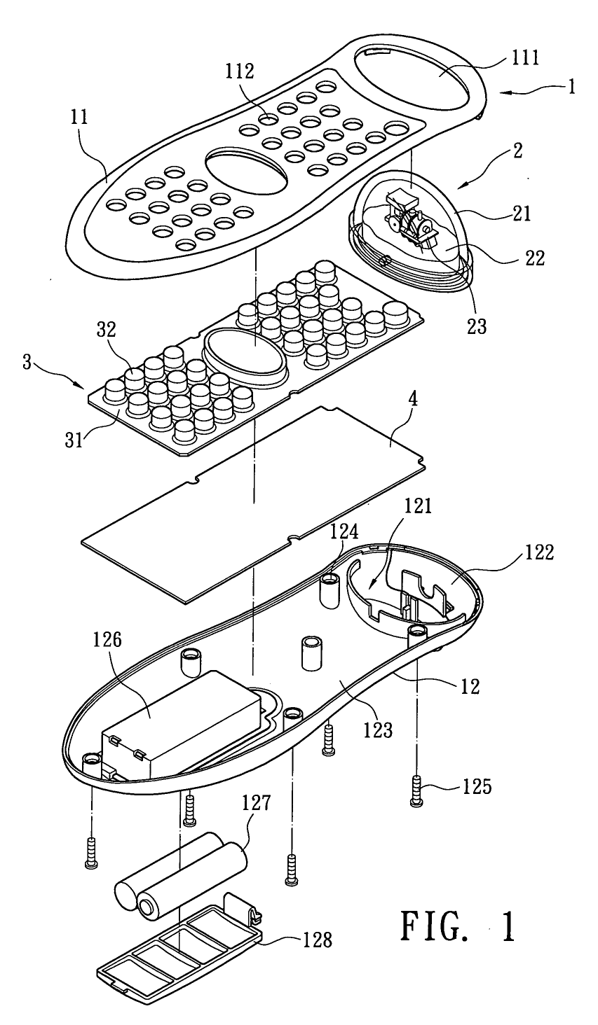

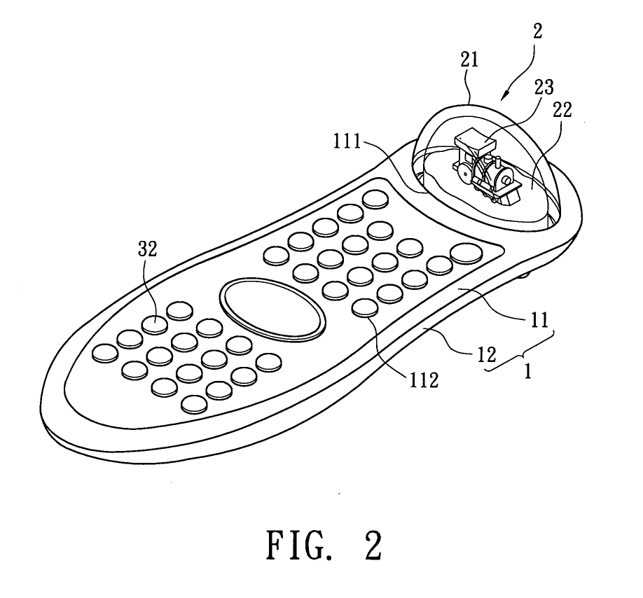

Referring to FIGS. 1 and 2, a remote controller in accordance with the present invention is shown comprised of a casing 1, an ornamental device 2, a keypad 3, and a circuit board 4.

The casing 1 is formed of a top cover shell 11 and a bottom cover shell 12. The bottom cover shell 121 comprises an accommodating chamber 121, which accommodates the ornament 2, a window 122 in front of the accommodating chamber 121 for output of signal from the circuit board 4, a receiving space 123 adjacent to the accommodating chamber 121, a plurality of hollow supporting members 124 suspended in the receiving space 123, a battery chamber 126 holding a set of battery cells 127, and a battery lid 128 covering the battery chamber 126 to hold the battery cells 127 in the battery chamber 126. A plurality of fastening members 125 are installed in the hollow supporting members 124 to affix the circuit board 4 and the top cover shell 11 to the bottom cover shell 121. The top cover shell 11 has an opening 111 corresponding to the accommodating chamber 121 of the bottom cover shell 121, and a plurality of through holes 112.

The ornamental device 2 is mounted in the accommodating chamber 121 of the bottom cover shell 12 and extended out of the opening 111 of the top cover shell 11, comprising a transparent watertight shell 21, a liquid (or a plurality of liquids of different specific gravity) 22 contained in the transparent watertight shell 21, and a floating ornament 23 floating on the liquid 22 inside the transparent watertight shell 21.

The keypad 3 is made of conducting rubber and supported on the circuit board 4 below the top cover shell 11, having a thin-sheet base 31 and a plurality of press keys 32 protruded from the top side of the thin-sheet base 31 and respectively inserted through the through holes 112 of the top cover shell 11.

The circuit board 4 is mounted inside the casing 1 and supported between the keypad 3 and the hollow supporting members 124 of the bottom cover shell 12. When the user pressed on press key 32 of the keypad 3, the circuit board 4 is driven to output a corresponding control signal through the window 122 to control the operation of the controlled electric (electronic) apparatus (not shown).

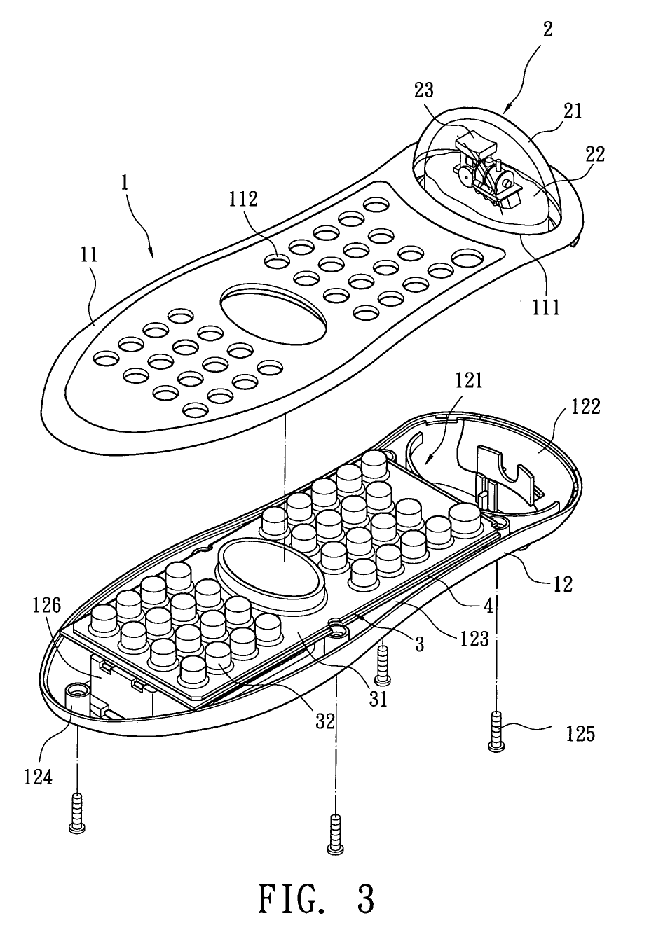

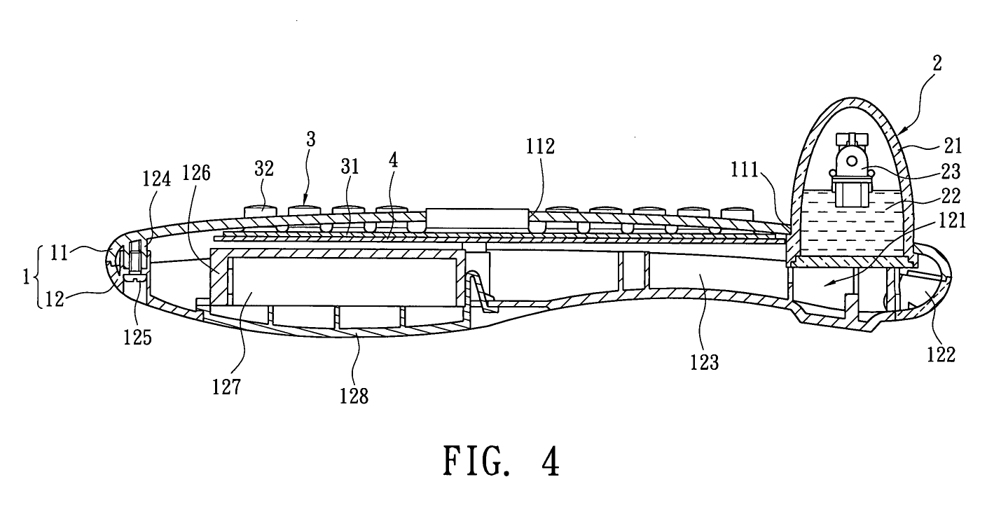

Referring to FIGS. 3 and 4, during assembly process, the ornamental device 2 is put in the accommodating chamber 122 of the bottom cover shell 12, then the circuit board. 4 is placed on the hollow supporting members 124 in the receiving space 123 of the bottom cover shell 12, and then the keypad 3 is placed on the circuit board 4, and then the top cover shell 11 is covered on the bottom cover shell 12 over the keypad 3 and the circuit board 4 to let the press keys 32 pass through the through holes 112 of the top cover shell 11, and then the fastening members 125 are respectively mounted in the hollow supporting members 124 and fastened to the top cover shell 11 to fixedly secure the top cover shell 11 to the bottom cover shell 12. Thereafter, the battery cells 127 are set in the battery chamber 126, and then the battery lip 128 is fastened to the battery chamber 126 to hold the battery cells 127 firmly in position. When assembled, the user can press the press keys 32 to drive the circuit board 4 to control the operation of the controlled electric (electronic) apparatus.

When holding the remote controller on the hand, the user can see the floating status of the floating ornament 23 on the liquid 22 inside the transparent watertight shell 21. When not in operation, the remote controller is used as a display toy.

Further, the floating ornament 23 can be made to have the shape of an animal, plant, or cartoon character. Alternatively, the floating ornament 23 can be marked with a company's logo for advertising purpose.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A remote controller and ornamental device arrangement comprising:
a casing, said casing comprising a bottom cover shell, a top cover shell covering said bottom cover shell, and a window in one of said bottom cover shell and said top cover shell at a front side thereof, said bottom cover shell and said top cover shell defining an ornamental device receptacle means;
an ornamental device mounted in said ornamental device receptacle means and partially exposed to the outside of said casing;
a circuit board mounted inside said casing between said bottom cover shell and said top cover shell; and
a keypad mounted within said top cover shell and supported on said circuit board for operation by the user to drive said circuit board to output a wireless control signal through said window to control the operation of an external electronic apparatus.

2. The remote controller and ornamental device arrangement as claimed in claim 1, wherein said top cover shell has a plurality of through holes; said keypad comprises a plurality of press keys respectively extended out of said through holes of said top cover shell for operation.

3. The remote controller and ornamental device arrangement as claimed in claim 1, wherein said bottom cover shell comprises a receiving space disposed adjacent to said ornamental device receptacle means for receiving said circuit board and said keypad.

4. The remote controller and ornamental device arrangement as claimed in claim 3, wherein said bottom cover shell comprises a plurality of hollow supporting members respectively suspended in said receiving space and adapted to support said circuit board and said keypad within said receiving space.

5. The remote controller and ornamental device arrangement as claimed in claim 4, further comprising a plurality of fastening members respectively installed in said hollow supporting members and fastened to said top cover shell to affix said top cover shell to said bottom cover shell.

6. The remote controller and ornamental device arrangement as claimed in claim 3, wherein said bottom cover shell comprises a battery chamber holding a battery set, and a battery lid covering said battery chamber.

7. The remote controller and ornamental device arrangement as claimed in claim 1, wherein said ornamental device comprises a transparent watertight shell holding at least one liquid, and a floating ornament floating on said at least one liquid inside said transparent watertight shell.

8. The remote controller and ornamental device arrangement as claimed in claim 7, the number of said at least one liquid is 1.

9. The remote controller and ornamental device arrangement as claimed in claim 1, wherein said at least one liquid includes different liquids having different specific gravity.

10. The remote controller and ornamental device arrangement as claimed in claim 1, wherein said keypad is conducting rubber device comprising a thin-sheet base and a plurality of press keys respectively upwardly protruded from a top side of said thin-sheet base; said top cover shell comprises a plurality of through holes adapted to accommodate said press keys.
